(19) United States
(12) Patent Application Publication
(10) Pub. No.: US 2013/0232830 A1
(43) Pub. Date: Sep. 12, 2013

(54) Method and apparatus for identifying a work object

(71) Applicant: Rebekah P. Barisic, Fresno, CA (US)

(72) Inventor: Rebekah P. Barisic, Fresno, CA (US)

(21) Appl. No.: 13/374,043

(22) Filed: Dec. 8, 2011

(51) Int. Cl. G09F 3/02

(52) U.S. Cl. CPC G09F 3/02
USPC 40/299.01

(57) ABSTRACT

A method for identifying a work object from among a plurality of work objects, the method including the steps of applying indicators to the work object which are individually selectable; and activating the indicators so as to indicate the work object with an identifying code. An apparatus for practicing the method using a plurality of protrusions each bearing a symbol and which can individually selectively be inverted to display an identifying code.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field of the Invention

The present invention relates to a method and apparatus for identifying a work object and, more particularly, to a method and apparatus which are operable to permit similar work objects readily to be distinguished from one another.

(2) Description of the Prior Art

A wide variety of environments exist in which items may be misplaced due to a mutiplicity of similar, or identical, items which have been placed in the general vicinity. Simply stated, the items are substantially indistinguishable from each other and/or are in such proximity to each other that identification of a given item from among the many is very difficult, if not impossible.

Some of the environments in which this experience may be present include, for example, any event at which there are a multiplicity of similar items and the nature of the event is such that the items involved are frequently, though, temporarily, set down. They may be set down for many reasons. For example, at athletic events, concerts, other social events, schools and other situations in which a considerable number of people congregate, the misplacement of bottles, cups, glasses and the like is a frequent occurrence. The items effectively become intermixed so as to be lost in the conglomeration.

This fact may lead to other consequences. The very fact that a person cannot be, or may not be, certain of the owner of the item, may create an uncomfortable lack of confidence. The item may effectively be contaminated in some respect. There may be a reticence because of the risk of the communication of unsanitary or otherwise unhealthful conditions. Real, or imagined, risk of such exposure is frequently enough for individuals not to assume the risk. The discomfort of knowing that you might drink from someone else's container frequently causes people not to take that chance, but rather to get a new drink in a new container. This, of course, causes waste, unnecessary expense, the proliferation of unfinished drinks, the spilling of abandoned drinks, and, more broadly, waste of natural resources.

There are many other environments in which such risks may be greater. For example, healthcare facilities such as hospitals, doctor's offices, nursing homes and the like may exacerbate these conditions. Knowledge that there actually are unhealthful conditions present intensifies these concerns among patients, nurses, doctors and other healthcare workers. Greater certainty as to the physical conditions to which they are exposed, or might be exposed, would be comforting as well as a useful tool in avoiding the spread of disease and the like as a result of mistake.

As a hedge against the intermixing of containers, it has been known for people to place their names on their containers using labels, or by marking directly on the container. However, in both such circumstances, it is common for condensation, contact, or other conditions to cause these identifiers to smear or otherwise come off. In other cases, containers of different, colors, shapes, sizes, or the like may be selected as a means for more certain identification. Of course, there are not enough distinguishing features available for this to serve the desired purpose.

Therefore, it has long been known that it would be of considerable advantage to have a method and apparatus which could be employed dependably to distinguish from among a plurality of substantially identical items; which could immediately afford the means for certain identification; which could operate with a dependability not heretofore achievable; which could rapidly be operated and without the disclosure to others of which may be, or be perceived to be, confidential information; which had application to a host of different types of work objects and environments; which reduced substantially the possibility of the communication of diseases, unhealthy conditions, or the like; and which would otherwise be entirely successful in achieving its operational objectives.

### BRIEF SUMMARY OF THE INVENTION

Therefore, it is an object of the present invention to provide an improved method and apparatus for identifying a work object.

Another object is to provide such a method and apparatus which can be employed in a wide variety of operative environments to permit work objects to be distinguishable one from another.

Another object is to provide such a method and apparatus which can be employed to achieve absolute certainty in identifying a specific work object.

Another object is to provide such a method and apparatus which have particular utility when used on containers for substances which may be consumed.

Another object is to provide such a method and apparatus which can be employed with a precision not heretofore achieved in the art.

Another object is to provide such a method and apparatus which can be used by people regardless of their visual acuity in identifying a specific work object rapidly and dependably.

Another object is to provide such a method and apparatus which can be employed without the dependence upon having access to any other items such as tools, markers, or the like.

Another object is to provide such a method and apparatus which have particular utility in large social gatherings, schools, hospitals, other healthcare facilities and the like.

Another object is to provide such a method and apparatus which have particular utility in providing a means for avoiding the spread of communicable diseases or otherwise unhealthful conditions, help to avoid waste, are of minimal cost and simplicity of use to a degree not heretofore available in the prior art.

Further objects and advantages are to provide improved elements and arrangements thereof in an apparatus for the purpose described which is dependable, economical, durable and fully effective in accomplishing its intended purposes.

These and other objects and advantages are achieved, in the preferred embodiment of the present invention, in a method and apparatus for identifying a work object from among a plurality of work objects, the apparatus including a plurality of identifiers mounted on the work object in a position to be visible; a plurality of different symbols individually borne by the identifiers; and a method for selecting one or more symbols borne by the identifiers to distinguish the work object from the plurality of work objects.

### BRIEF DESCRIPTION OF THE SEVERAL VIEWS OF THE DRAWINGS

FIG. 1 is a perspective view of a work object, in this case a disposable water bottle, employing the method and having apparatus of the present invention.

FIG. 2 is a side elevation of the bottle of FIG. 1.

FIG. 3 is a transverse vertical section of the bottle of FIG. 1 taken on line 3-3 in FIG. 2.

FIG. 4 is a fragmentary side elevation of the bottle of FIG. 1 showing the method and apparatus of the present invention thereon.

FIG. 5 is a perspective view of a second embodiment of the method and apparatus of the present invention.

FIG. 6 is an enlarged fragmentary transverse horizontal section of the bottle of FIG. 1 showing several portions of the method and apparatus of the present invention employed in the practice thereof.

### DETAILED DESCRIPTION OF THE INVENTION

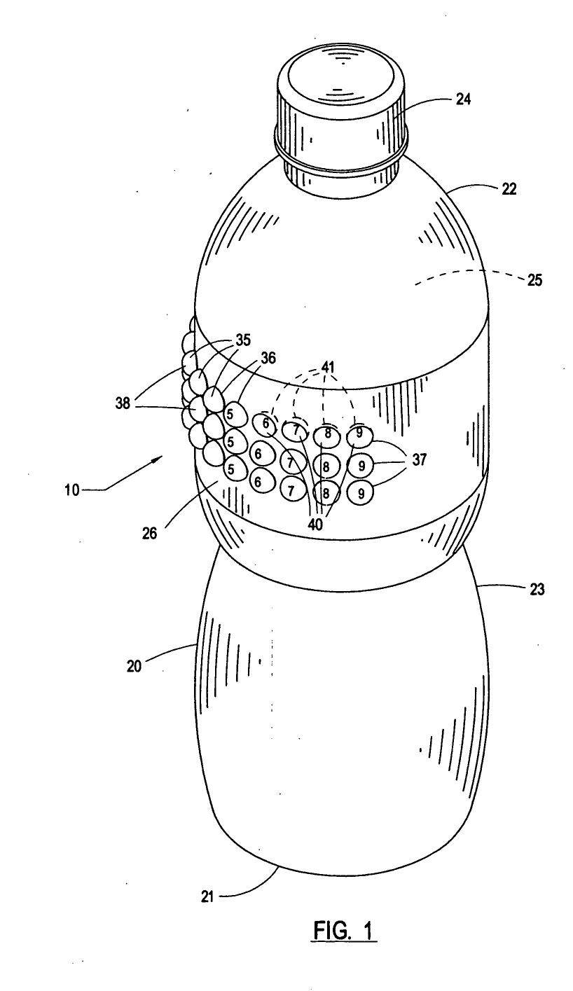

Referring more particularly to the drawings, the apparatus of the present invention is generally indicated by the numeral 10 in FIG. 1. As shown in FIG. 1 and the subsequent views, the apparatus is borne by, and the method is practiced with respect to, a work object 20 which, in this case and for illustrative convenience, is a plastic water bottle. It will be understood that virtually any type of work objects can be the subject of the method and apparatus of the present invention, whether they hold liquid for drinking or another type of consumable, or are used for entirely different purposes.

The work object or water bottle 20 has a bottom wall 21 and a top wall 22 at the opposite end thereof. The water bottle has a side wall 23, which interconnects the bottom wall and top wall, and a cap or lid assembly 24. The water bottle has an interior 25 containing a consumable. In this case, of course, the consumable is drinking water. For purposes of illustrative convenience, the water bottle can be viewed as having an identifier zone 26 which is preferably, although not necessarily, on the side wall 23 on the upper portion of the water bottle adjacent to the top wall 22 and extending entirely about the water bottle.

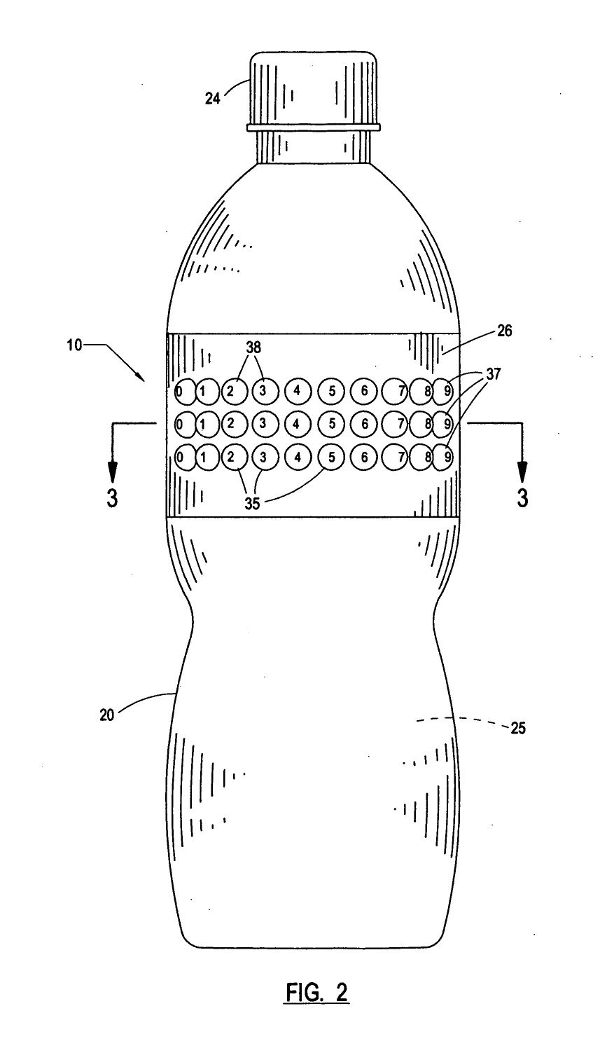

A plurality of indicators, identifiers, or protrusions 35 are mounted in spaced relation to each other on the water bottle in the identifier zone 26 of the side wall 23. In the illustrative embodiment hereof, the protrusions are arranged in ten vertical rows 36 and three horizontal rows 37, as best shown in FIG. 2. Each of the protrusions has an outer convex surface 38 and an inner concave surface 39. The operation of the method and apparatus of the present invention encompasses depression of selected protrusions which converts each such protrusion so that it inverts inwardly to protrude toward the interior 25 of the water bottle. Each such protrusion is thus caused to have an outer inverted concave surface 40 and an inner inverted convex surface 41. It will be understood that the thickness and composition of the plastic material from which the water bottle is made is such that a certain amount of flexing of the side wall 23 takes place upon the application of pressure thereto. The opposite convex and concave surfaces 38 and 39 respectively of the protrusions 35 are hemispheres. Each protrusion can be flexed upon the application of individual pressure thereto such as with the thumb of the person using it. Such flexing causes the convex surface to flex inwardly to form a concave surface facing outwardly. This occurs without bending, or denting the sidewall.

A symbol 42 is printed, or otherwise formed, on the outer surface of each protrusion, as best shown in FIG. 1. In the illustrative example hereof, the symbols are identified by numerals 42. As shown in FIG. 1, in the illustrative example, the protrusions form a vertical row having the same numeral thereon while each of the three horizontal rows has numerals in sequence from “0” to “9”. It will be understood that other symbols can alternatively be employed, such as alphabetical letters, geometric symbols, other types of symbols, or the like.

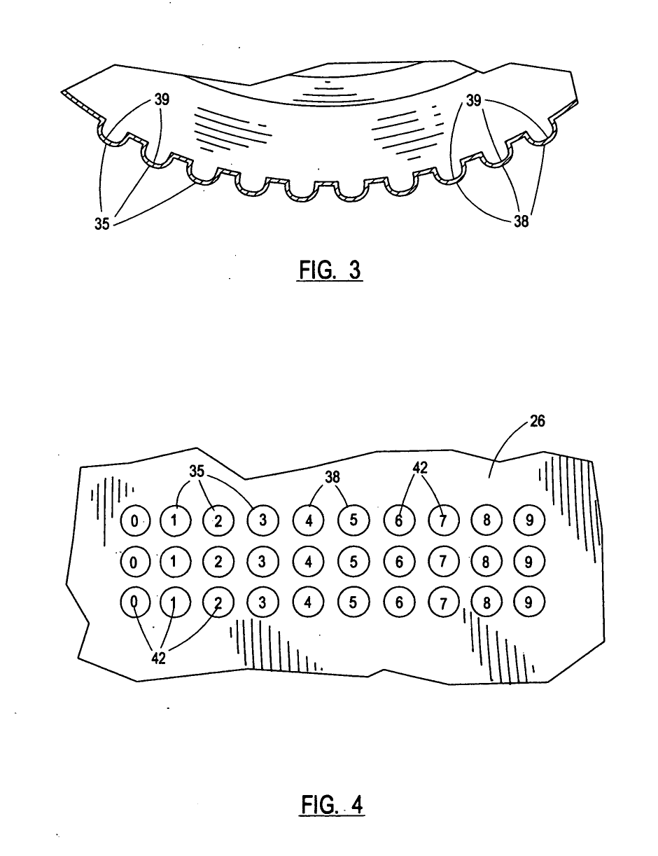

It will be seen in FIGS. 2, 3 and 5 that none of the protrusions have yet been depressed to cause them to invert. Conversely, in FIGS. 1 and 6 protrusions “6”, “7”, “8” and “9” in a single horizontal row 37 have been depressed to cause them to invert thereby creating an identifying code. The illustrative identifying code is thus “6789” which could, for example, correspond to a person's street address. Alternatively, the inverted protrusions can be selected in ten different vertical rows, or any other combination thereof.

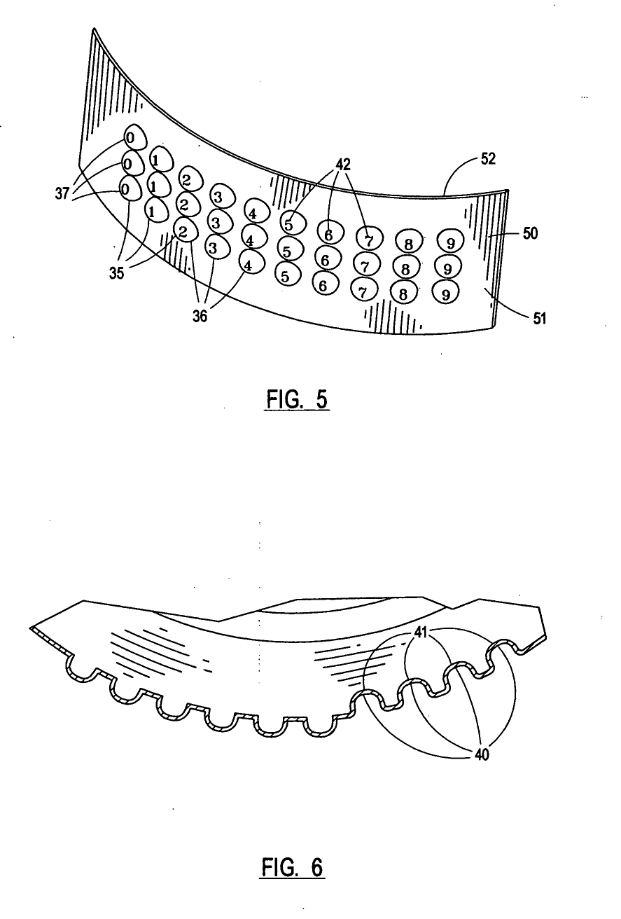

FIG. 5 shows a second embodiment of the method and apparatus of the present invention. FIG. 5 shows an attachment plate 50 of the second embodiment. The attachment plate can be constructed of any suitable material, such as a plastic and has a front surface 51 and an opposite back surface 52. The back surface preferably bears an adhesive which permits it to be adhesively attached to any type of work object, such as a water bottle. Since the attachment plate is plastic, it has flexibility allowing it to be adhesively attached to a work object of any size. The front surface 51 mounts the protrusions 35 which are used in the same manner and for the same purpose as the protrusions of the first embodiment of the subject invention heretofore set forth.

### OPERATION

The operation of the described embodiment of the subject invention is believed to be clearly apparent and is briefly summarized at this point.

Operation of the method and apparatus of the subject invention can, perhaps, best be illustrated using a representative environment of usage. For this purpose, it will be understood that the environment of use is a social event at which there are many people drinking consumables from bottles, cups and the like. In this illustrative example, the bottles, cups and the like are all equipped so as to be operable in accordance with the method and apparatus of the present invention.

In this environment, each person with such a bottle, cup, or the like can press inwardly of the side wall 23 selected protrusions 35 so as, in effect, to create a code to identify that bottle, cup, or the like. Pressure toward the interior 25, by for example using the thumb, causes the selected protrusion to invert, or in other words to become recessed, or concave. This concave configuration, in effect, appears to circle the number selected. Once a code is so formulated, it has the general appearance shown in FIGS. 1 and 6. The specific code selected could, or course, be any combination of numbers such as, for example, the telephone number or street address of the person whose bottle, cup or other vessel is being used. Alternatively, as another example, the specific code could be entirely randomly selected.

In any case, all of the work objects so designated are rapidly distinguishable from each other with absolute certainty. Accordingly, all of the problems experienced in conventional situations are avoided. Furthermore, in view of there being three rows of ten choices each, the number of choices is so large as to make it virtually impossible that two or more people could by chance choose to select the same code.

In addition, since the protrusions in both their respective convex and concave forms extend out of the plane defined by the side wall 23, there is a distinguishable tactile sensation by running one's fingers over them. Accordingly, a person with limited or otherwise compromised eyesight, knowing the arrangement of the protrusions and the numerals thereon, can use the method and apparatus of the present invention for its intended purpose relying entirely on the sense of touch.

Therefore, the method and apparatus of the present invention can be employed to distinguish an item from a plurality of substantially identical items; can immediately provide certain identification of the item; is entirely dependable in use and not subject to failure; can be used in such a way as to maintain confidentiality if desired; has application to a multiplicity of different environments of use; can be employed so as to avoid the possibility of the communicable diseases; and is otherwise entirely successful in achieving its operational objectives.

Although the invention has been herein shown and described in what is conceived to be the most practical and preferred embodiment, it is recognized that departures may be made therefrom within the scope of the invention which is not to be limited to the illustrative details disclosed.

Having described my invention, what I claim as new and desire to secure by Letters Patent is:

1. A method for identifying a work object from among a plurality of work objects, the method comprising the steps of:
applying indicators to said work object which are individually selectable; and
activating the indicators so as to identify said work object.

2. The method of claim 1 wherein said work objects are containers of consumable substances and wherein the activating step includes entering an identifying code for purposes of reference.

3. The method of claim 1 wherein said indicators in the applying step include symbols which are selected in said activating step.

4. A method for identifying a container so as to distinguish it from other containers of similar type, the method comprising the steps of:
forming said containers with a plurality of indicators which individually bear symbols of a plurality of different forms;
selecting one or more of said symbols; and
indicating those symbols selected in the selecting step by making said symbols selected so as to form an identifying code.

5. The method of claim 4 wherein in said forming step the plurality of indicators are protrusions in the container which, in said selecting step, are pushed to cause inversion of said protrusions bearing said symbols selected.

6. The method of claim 5 wherein said symbols are different numbers borne by said protrusions.

7. An apparatus for identifying a work object from among a plurality of work objects, the apparatus comprising a plurality of identifiers mounted on said work object in position to be seen; a plurality of different symbols individually borne by said identifiers; and means for selecting one or more symbols borne by the identifiers to distinguish said work object from said plurality of work objects.

8. The apparatus of claim 7 wherein said plurality of identifiers are mounted on a plastic member which is, in turn, attached to the work object by the person using the work object.

9. The apparatus of claim 7 wherein said work objects are individual containers of consumables and said identifiers are a plurality of protrusions in said containers, and said symbols are numbers individually borne by said protrusions.

10. The apparatus of claim 9 wherein said selecting means includes said protrusions being deformable to indicate those symbols selected thereby to display a code distinguishing said container from another container.

11. In a container for housing a substance to be dispensed having a plastic sidewall, an apparatus comprising a plurality of convex rounded protrusions formed in said plastic sidewall; different symbols individually displayed on the rounded protrusions; and means permitting said individual rounded protrusions selectively to be depressed to cause said depressed protrusions to invert to form concave surfaces bounding said symbols whereby a code is thereby entered on said container to distinguish it from other containers.

12. The apparatus of claim 11 wherein said symbols are numbers.

13. The apparatus of claim 12 wherein there are a plurality of said rounded protrusions formed in rows on said plastic sidewall of the container each individually bearing a number from 0 to 9 whereby any personalized number code can be displayed by depressing the appropriate protrusions to form said concave surfaces.
